(19) United States
(12) Patent Application Publication
(10) Pub. No.: US 2003/0079136 A1
(43) Pub. Date: Apr. 24, 2003

(54) Security framework

(76) Inventors: Emmanuel Ericta, Potomac, MD (US); Sharon Smithwick, Rockville, MD (US)

Correspondence Address: FISH & RICHARDSON PC, 225 FRANKLIN ST, BOSTON, MA, 02110, US

(21) Appl. No.: 10/175,942

(22) Filed: Jun. 20, 2002

Related U.S. Application Data
(60) Provisional application No. 60/313,954, filed on Aug. 21, 2001.

(51) Int. Cl. H04L 9/32

(52) U.S. Cl. 713/185

(57) ABSTRACT

A process, which resides on a server, regulates the application functionality and network access of a user. An application permission configuration process assigns an application permission token to one or more application functionalities of an application running on the server. A user permission configuration process regulates the access of a user to the application permission tokens assigned by the application permission configuration process. This defines the application access rights of the user, such that a user who has access to an application permission token is granted access to its related application functionality. A database stores the application permission tokens of the application and the application access rights of the user.

### RELATED APPLICATIONS

This application claims the priority of U.S. Provisional Patent Application No. 60/313,954, filed on Aug. 21, 2001, and entitled “Web Security Framework”.

### BACKGROUND

This invention relates to network-based security.

Computer networks (e.g., local area networks, wide area networks, intranets, extranets, the internet, etc.) allow computer users to share information and data files. A user, when logging into a computer network, is typically required to enter a user I.D. and password that identifies the user, grants the user access, and assigns the user rights to resources available on the network.

As the level of access granted to users typically varies from user to user, the resources, data files, and applications available to the individual users will also vary.

Computer networks that provide access to sensitive data often use data encryption and enhanced security procedures to prevent unauthorized access to the sensitive data and system resources of the network.

### SUMMARY

According to an aspect of this invention, a process, residing on a server, regulates the application functionality and network access of a user. An application permission configuration process assigns an application permission token to one or more application functionalities of an application running on the server. A user permission configuration process regulates the access a user has to the application permission tokens assigned by the application permission configuration process. This defines the application access rights of the user, such that a user who has access to an application permission token is granted access to its related application functionality. A database stores the application permission tokens of the application and the application rights of the user.

One or more of the following features may also be included. The application permission configuration process includes a functionality configuration process for defining the application functionalities (e.g., a web-based process or a uniform resource locator available on a website). An application record maintenance process produces an application database record for the application running on the server. An application token record maintenance process produces an application token database record for each application permission token assigned to the application functionalities of the application running on the server. A user record maintenance process produces a user database record for the user.

The database includes a network domain database (e.g., a Windows NT tm domain user and group database) and a security framework database (e.g., a SQL database). The application database records, application token database records, and user database records are stored on both the network domain database and the security framework database.

A user enrollment process authenticates a newly-added user by requiring the newly-added user to prove their identity. An authenticity certificate is then produced for and provided to the newly-added user. This authenticity certificate identifies the newly-added user and includes a unique encryption key for encrypting any data communicated between the user's computer and the server. A network authentication process authenticates a user upon login by comparing information encoded within the authenticity certificate to information stored on the database.

The user enrollment process includes a user personal information input process that requires the newly-added user to provide personal information prior to the creation of their authenticity certificate. The user enrollment process also includes a manual verification process that requires an administrator to approve the personal information entered by the user.

A role maintenance process maintains a user group such that all members of the user group have equivalent access to the permission tokens assigned by the application permission configuration process.

A folder permission configuration process assigns a folder permission token to one or more folders within a directory structure. The user permission configuration process is configured to regulate the access of the user to these folder permission tokens assigned by the folder permission configuration process. This defines the folder access rights of the user, such that a user who has access to a folder permission token is granted access to its related folder. A folder token record maintenance process produces a folder token database record for each folder permission token assigned to the folders within a directory structure. These folders maybe a directory folder within the file directory of the server or a file transfer protocol (FTP) folder on an FTP server.

According to a further aspect of this invention, a method for regulating the application functionality and network access of a user includes assigning an application permission token to one or more application functionalities of an application running on the server. The access that a user has to these application permission tokens is regulated. This, in turn, defines the application access rights of the user, such that a user who has access to an application permission token is granted access to its related application functionality. The application permission tokens of the application and the application access rights of the user are stored on a database.

One or more of the following features maybe included. Assigning an application permission token includes defining the application functionalities. An application database record is produced for each application running on the server. An application token database record is produced for each application permission token assigned to the application functionalities of the application running on the server. A user database record is produced for each user of the server. Newly-added users are authenticated by requiring the newly-added users to prove their identify. An authenticity certificate is then produced for and provided to the newly-added user. The authenticity certificate identifies the newly-added user and includes a unique encryption key that encrypts any data communicated between the user's computer and the server. The user is authenticated upon login by comparing the information encoded within the authenticity certificate to the information stored on the database. Authenticating newly-added users further includes requiring the newly-added user to provide personal information prior to the creation of the authenticity certificate and requiring an administrator to approve the personal information entered by the user.

A user group is produced such that all members of the user group have equivalent access to the permission tokens assigned by the application permission configuration process.

A folder permission token is assigned to one or more folders within a directory structure. Regulating the access of a user is configured to regulate the access of a user to the folder permission tokens assigned by the assigning a folder permission token. This defines the folder access rights of the user, such that a user who has access to a folder permission token is granted access to its related folder. A folder token database record is produced for each folder permission token assigned to the folders within the directory structure.

According to a further aspect of this invention, a computer program product, which resides on a computer readable medium, has a plurality of instructions stored on it. When executed by the processor, these instructions cause the processor to assign an application permission token to one or more application functionalities of an application running on a server. The computer program product regulates the access of a user to the application permission tokens assigned by the assigning an application permission token. This defines the application access rights of the user, such that a user who has access to an application permission token is granted access to its related application functionality. Computer program products stores, on a database, the application permission tokens of the application and the application access rights of the user.

One or more advantages can be provided from the above. Network security can be enhanced. By allowing an administrator to assign tokens to the various functionalities of an application, user access rights can be fine tuned to an enhanced level. By combining traditional logon procedures (i.e., user names and passwords) with authenticity certificates, network security can be further enhanced. By utilizing tokens to assign rights to individual folders within an FTP directory structure, the folder access can also be refined and enhanced.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a network security process; and

FIG. 2 is a flow chart depicting a method for providing network security.

### DETAILED DESCRIPTION

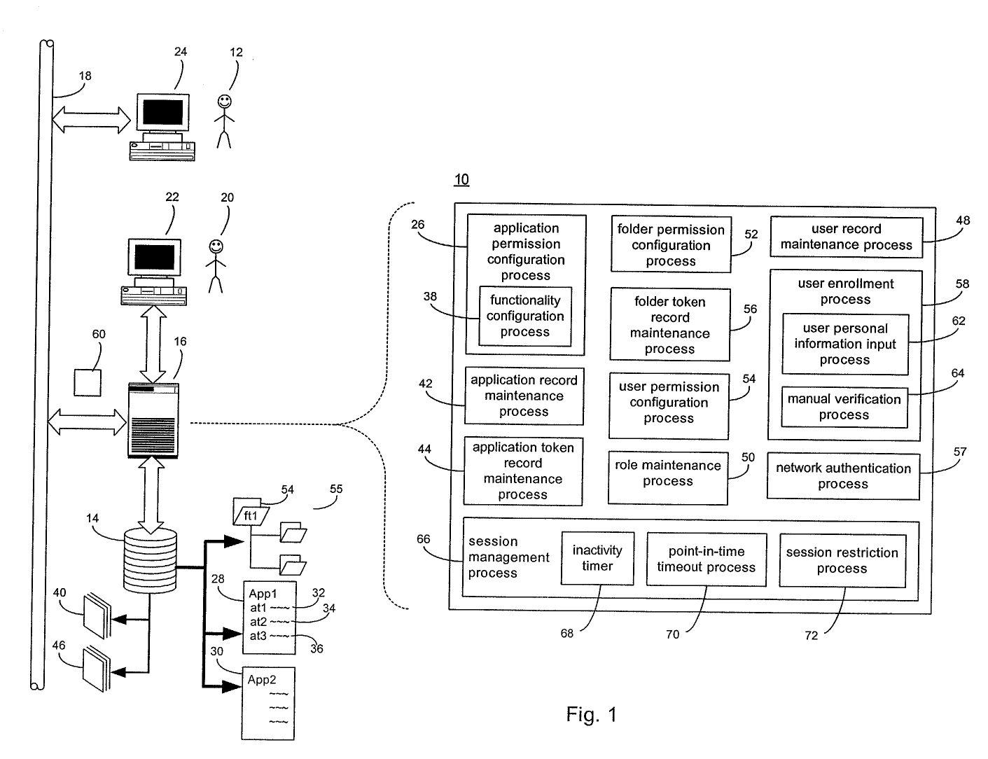

Referring to FIG. 1, a process 10 regulates the application functionality and network access of a user 12. Process 10 resides on a storage device 14 on server 16. This storage device 14 can be a hard disk drive, a tape drive, an optical drive a RAID array, a random access memory (RAM), or a read-only memory (ROM). Distributed computing network 18 can be the Internet, an intranet, a local area network, an extranet, or any other form of network environment. Process 10 is typically administered by an administrator 20 using a graphical user interface (not shown) running on a remote computer 22, which is also connected to network 18. The graphical user interface can be a web browser, such as Microsoft, Internet Explorer™ or Netscape Navigator™. A network user 12 typically accesses process 10 and the data and resources stored on storage device 14 through a remote computer 24 that is also connected to network 18.

Process 10 is typically a web-enabled process that is accessible through a web browser. Since web browsers are cross-platform compatible, by configuring process 10 so that it is a web-based process, any hardware compatibility issues concerning remote computers 22, 24 are reduced. Server 16 runs web server software, such as Microsoft Internet Information Server tm, to facilitate process 10 operation in a web environment.

Process 10 includes an application permission configuration process 26 that allows administrator 20 to assign an application permission token to one or more application functionalities 32, 34, 36 of an application 28, 30 running on server 16. These application functionalities 32, 34, 36 can be any process or sub-process of an application. Additionally, if the application is a web-based application usable through a web-browser, a functionality could be an embedded link, such a URL. Examples of these application functionalities 32, 34, 36 are: a print file command; a save file command; a open file command; a link to a remote website; a report generation command; a report review command; a database query; for example. Application permission tokens “at1”, “at2”, and “at3” are unique identifiers used by process 10 to identify each application functionality of the application to which they are assigned. For example, “at1” may be an application permission token that corresponds to a database query command on a web page, “at2” may be an application permission token that corresponds to a compiled report command on a web page, and “at3” may be an application permission token that corresponds to a print report command on a web page, such that each of these commands represents a unique functionality of the application. By regulating the access that a user 12 has to these application permission tokens “at1”, “at2” and “at3”, the users' access to the various application functionalities 32, 34, 36 of an application 28 can be controlled.

The individual application functionalities of the application 28 are configured by administrator 20 using computer 22. Application functionality 32, 34, 36 can be individual applets or links within a web page, or commands and procedures available in non-web-base applications, such as word processors, spreadsheets, databases, etc. For example, an application functionality can be the new file command in a word processor, the print file command in a word processor, the recalculate command in a spreadsheet, the edit query command in a database, the redraw command in a graphics program, etc.

Concerning web-based applications and web pages, an application functionality can be a link (i.e., URL) that allows a user to access another web page or web-based process, or the application functionality can be the web-based process itself. For example, the intranet homepage of a company's internal website may be accessible by all employees. However, a link on that homepage to an employee name directory web page may be an application functionality that is restricted, via permission tokens, so that only low-level managers (and above) can access this page. On this employee name directory web page is an employee search query box that allows users to search the employee records to determine various pieces of semi-confidential information (such as starting dates, home addresses, etc.). The use of this search command within this employee name directory web page may be configured as a separate application functionality and, therefore, further restricted (via permission tokens) so that only mid-level managers (and above) can execute that search command and view the search results. Further, assume that also within this employee name directory web page, there is a separate link that goes to an employee salary webpage that lists the salary of each employee within the company. Obviously, this is highly confidential information that should only be made available to high level managers within the company. Therefore, the link to this employee salary webpage is a separate application functionality that is further restricted, via permission tokens, so that only high level managers have access to this sensitive information.

During initial configuration of an application 28 by administrator 20, a functionality configuration process 38 incorporated into application permission configuration process 26 is used by administrator 20 to assign application permission tokens to various application functionalities of the application being configured. Administrator 20 can assign application permission tokens to as many or as few application functionalities of the application. Accordingly, administrator 20 can fully control and configure the access intricacy level associated with an application.

Process 10 maintains a database 40, which typically resides on storage device 14 that specifies each application 28, 30 and application permission token “at1”, “at2”, and “at3”, configured by administrator 20. Each time an application is initially configured by administrator 20, database 40 is modified to include a record for that newly-configured application. Information included in this record can be information concerning the manufacturer of the program, the name of the program, the version of the program, the date configured, etc. Additionally, each application permission token “at1”, “at2”, and “at3”, added for any application 28, 30 will have its own database record.

Typically, the nomenclature of these database records is such that the name of the record for an application permission token references the application to which that application permission token belongs. For example, if the database application record for an application installed on server 16 is “app1”, the database record for the first application permission token for that application may be “app1t1”. Examples of the information included in the database record for an application permission token include the name of the application permission token, the application to which it is associated, the application functionality to which it is associated, etc. Examples of database 40 are a SQL™ database, an Oracle™ database, a Sybase™ database, an Access™ database, etc. Process 10 includes an application record maintenance process 42 for producing the database records for each application (e.g., 28, 30) configured by administrator 20. Additionally, an application token record maintenance process 44 produces the database record for each application permission token (e.g., “at1”, “at2”, and “at3”) configured by administrator 20.

In addition to database 40, which is a stand-alone database produced and maintained by process 10, a second database 46 is also modified and maintained by process 10. Database 46 is the network domain database of the network operating system (NOS) that runs on server 16 and allows communication over network 18. Specifically, network operating systems, such as Windows NT Server™, Windows 2000 Advanced Server™, and Novell Netware™, use an internal database to administer these network operating systems. Typically, these databases include database records for network users, services installed by the network, applications available on the network, user groups, security rights, etc. This database 46 that is produced and maintained by the network operating system running on server 16 is also modified by process 10 each time an application 28, 30 or an application permission token “at1”, “at2”, “at3” is configured by administrator 20. Typically, database 46 mirrors the information included in database 40. However, being database 40 is a specialized database produced and maintained by process 10, the individual records in database 40 contain more information than the corresponding records in database 46. Accordingly, each time an application 28, 30 is configured in process 10 by administrator 20, an application record is produced in database 46. Additionally, each time an application permission token “at1”, “at2”, “at3” is configured in process 10 by administrator 20, an application token database record is also produced in database 46. Typically, application token database records are configured as groups in databases 40 and 46 and any user who is a member of these groups has access to that application permission token and, therefore, the application functionality associated with that application permission token.

In addition to configuring applications and permission tokens “at1”, “at2”, “at3”, the administrator also configures the individual users 12 of process 10. The users are configured so that a user's access to the application functionalities 32, 34, 36 of an application 28 can be regulated. Accordingly, process 10 includes a user record maintenance process 48 that allows administrator 20 to add and delete (i.e., manage) users 12 from process 10. Each time administrator 20 produces a user 12 on process 10, a user database record is produced in databases 40 and 46. As stated above, each of these databases includes a record for each application permission token configured by administrator 20. Further, as stated above, by granting a user access to these application permission tokens “at1”, “at2”, “at3”, user 12 gains access to the application functionalities associated with each one of these tokens. Therefore, since each database record concerning an application permission token is configured as a group, by adding a user (i.e., making them a member) to one of these groups, that user would have access to that application permission token and, therefore, the functionality related to that application permission token. In the event that a user's access is changed, this user can be added to or removed from the database records (i.e., groups) of each application permission token via user record maintenance process 48.

Typically, similarly situated users are granted identical access rights. For example, it is not uncommon for all new employees at a company to be granted only basic access rights, while mid-level management has enhanced rights, upper level management has superior rights, and administrators have complete access. Accordingly, it is desirable to be able to configure each of these various levels of access rights as a separate group, such that all the members of the group have the same access rights. This allows administrator 20 to quickly configure users by adding or removing them from these user groups. A role maintenance process 50 allows for the production of such user groups. Through role maintenance process 50, administrator 20 can define a user group in which its members all have equivalent permission to various application permission tokens (e.g., “at1”, “at2”, and “at3”). Therefore, by making a user 12 a member of a user group produced by role maintenance process 50, that user will have the rights of the group as defined by administrator 20, namely access to the specific application permission tokens defined by administrator 20.

In addition to the above-described ways in which process 10 controls a user's access to various application functionalities, process 10 can also control a user's access to various folders and sub-folders within a directory structure. A folder permission configuration process 52 assigns a folder permission token (e.g., “ft1”) to one or more folders 54 within a directory structure 55. Directory structure 55 may be the file structure of a file transfer protocol a (FTP) server or may be the folders or directories of a local hard drive or remote server drive.

Regardless of the type of token assigned (i.e., an application permission token or a folder permission token), a user permission configuration process 54 regulates the access that user 12 has to the application and/or folder permission tokens (which were assigned by administrator 20 using either application permission configuration process 26 or folder permission configuration process 52). This, in turn, regulates the access that user 12 has to the related application functionalities and/or folders.

Accordingly, each time a user 12 tries to access an application functionality 32, 34, 36, and/or a folder 54, user permission configuration process 54 accesses the user database record for that user to determine if they have access to the tokens associated with these functionalities and/or folders. As explained above, these can be discrete access rights to specific tokens or can be membership in a group in which all members of the group have defined access rights. In the event that user 12 does not have the proper application access rights (for a specific application functionality) or folder access rights (for a specific folder in a directory structure) that user's access to the application functionalities and/or folder contents respectively will be denied.

As with the application permission tokens, each time a folder permission token is produced, a folder token record maintenance process 56 updates databases 40 and 46 to include a folder token database record for each folder permission token (e.g., “ftl”) assigned by administrator 20.

Each time a new user is added, that newly-added user is authenticated by a user enrollment process 58 that requires the user to prove their identity when they first log into server 16. Typically, when administrator 20 adds user 12, the administrator assigns them a user name and a temporary password. When user 12 subsequently logs into process 10 using that user name and temporary password, that login itself can serve as proof of their identity. Additionally, upon logging in, user 12 may be required (by user enrollment process 58) to provide sensitive information known only to the user (e.g., the user's social security number, mother's maiden name, favorite pet's name, etc.).

Once user 12 proves their identity to the level required by administrator 20, user enrollment process 58 generates an authenticity certificate 60 that is provided to user 12. Authenticity certificate 60 is typically stored on the remote computer 24 that user 12 uses to access server 16 and process 10. Authenticity certificate 60 identifies the user (typically using some form of serial number) and may include a unique encryption key (not shown) for encrypting any data communicated between the user's computer 22 and server 16. Therefore, any future communications between these computers will utilize encrypted data.

Once this authenticity certificate 60 is produced for newly-added user 12, that user may be required to enter personal information about themselves in order to complete the enrollment process. If this personal information is desired/required by administrator 20, a user personal information input process 62 requires user 12 to enter this information upon first logging into server 16. Examples of this information are first name, middle name, last name, home address, city, state, zip, home phone number, date of birth, date of employment, job title, etc.

Alternatively, administrator 20 may configure user personal information input process 62 so that the authenticity certificate 60 is not produced until after the user submits the personal information and it is accepted. For example, a manual verification process 64 may require that the personal information entered by user 12 be approved by administrator 20 prior to user 12 completing the enrollment process. Therefore, user 12 may not receive the authenticity certificate 60 until not only the new user enters their personal information, but that information is reviewed and approved by administrator 20.

Once this personal information is entered by user 12 and accepted by administrator 20, the authenticity certificate 60 will be provided to user 12. As stated above, this authenticity certificate 60 is stored locally on user's computer 22. When user 12 logs into server 16, user 12 will be prompted for their user name and password. Upon acceptance of the user name and password by server 16, process 10, and the network operating system running on server 16, the user database record for user 12 will be accessed from database 40 and/or 46.

As stated above, these user database records typically identify the user by a unique serial number that is also included on that user's certificate of authenticity 60. Therefore once process 10 obtains the serial number for user 12 from databases 40 and/or 46, process 10 requests a copy of the certificate stored locally on user's computer 22. A network authentication process 57 then compares the serial number encoded within certificate of authenticity 60 to the serial number in that user's database record.

In the event that the certificate of authenticity 60 does not exist, or the serial number encoded within the certificate of authenticity does not match the serial number assigned to that user, user 12 will be denied access to server 16 and process 10. However, if the serial number stored on the user's database record matches the serial number encoded within the certificate of authenticity 60 stored on computer 22, that user 12 will be granted access to server 16 and allowed to log in. At this point, the access rights (both application and folder), will be determined for that user by looking up the tokens (e.g., “at1”, “at2”, “at3” and “ft1”) assigned to that user.

In addition to defining the rights of user 12 manually, administrator 20 may import a text file (not shown) from a remote computer (not shown) such as a main frame. This would enable process 10 to be quickly configured such that the access rights specified by process 10 are identical to the access rights of the users of a process running on a remote computer, thus allowing for rapid system deployment and configuration.

A session management process 66 polices and verifies the integrity of the sessions (or connections) between the users (e.g., user 12) and process 10.

Session management process 66 includes an inactivity timer 68 for monitoring the amount of time that a session has been inactive (e.g., no data or information entered by the user). In the event that the session has been inactive for greater than a defined period of time (as defined by administrator 20), that session is disconnected. Therefore, if disconnected, user 12 will be required to reestablish the session before they may continue to use process 10. The length of this defined period of time may be varied depending on the particular application that the user is working on.

Session management process 66 also includes an point-in-time timeout process 70 for disconnecting sessions at an administrator-defined point in time. This enables all sessions (or a portion thereof) to be disconnected at a specific time of day, thus allowing, for example, the performance of maintenance tasks on process 10 or server 16.

Additionally, session management process 66 includes a session restriction process 72 that prevents multiple users from logging into process 10 and/or server 16 using a single user ID. As stated above, when a user logs into server 16, that user is prompted to enter their user name and password. Upon acceptance of the user name and password by server 16, process 10, and the network operating system running on server 16, the user database record for user 12 is accessed from database 40 and/or 46. A session record is created (in database 40) for the user's current session. Written into this session record is a unique browser ID that is obtained from the web browser that user 12 is using to access process 10. This session record uniquely identifies the computer currently being used by user 12 and, therefore, uniquely identifies that user's current session. Further, each time a new session is established for user 12, a new session record is created and any previously established session is suspended.

Therefore, assume that an unauthorized user (not shown) obtained the user name and password of an authorized user 12 and also obtained a copy of that authorized user's certificate of authenticity 60. If the authorized user 12 is logged into process 10 and the unauthorized user subsequently logs into process 10, a new session record is generated for the unauthorized user (and the unauthorized user's computer browser) and the session record for the session previously established by user 12 is deleted. This, in turn, results in the session of user 12 being terminated. Since user 12 is now prevented from any further use of process 10, user 12 is constructively notified that their user ID, password, and/or certificate were compromised.

Session restriction process 72 may be interfaced with user record maintenance process 48 so that in the event that multiples users log in (or attempt to log in) using a single user ID, user record maintenance process 48 disables or deletes that user ID. This is done on the premise that the confidentiality of that user ID was compromised and, therefore, a new user ID should be created for that user.

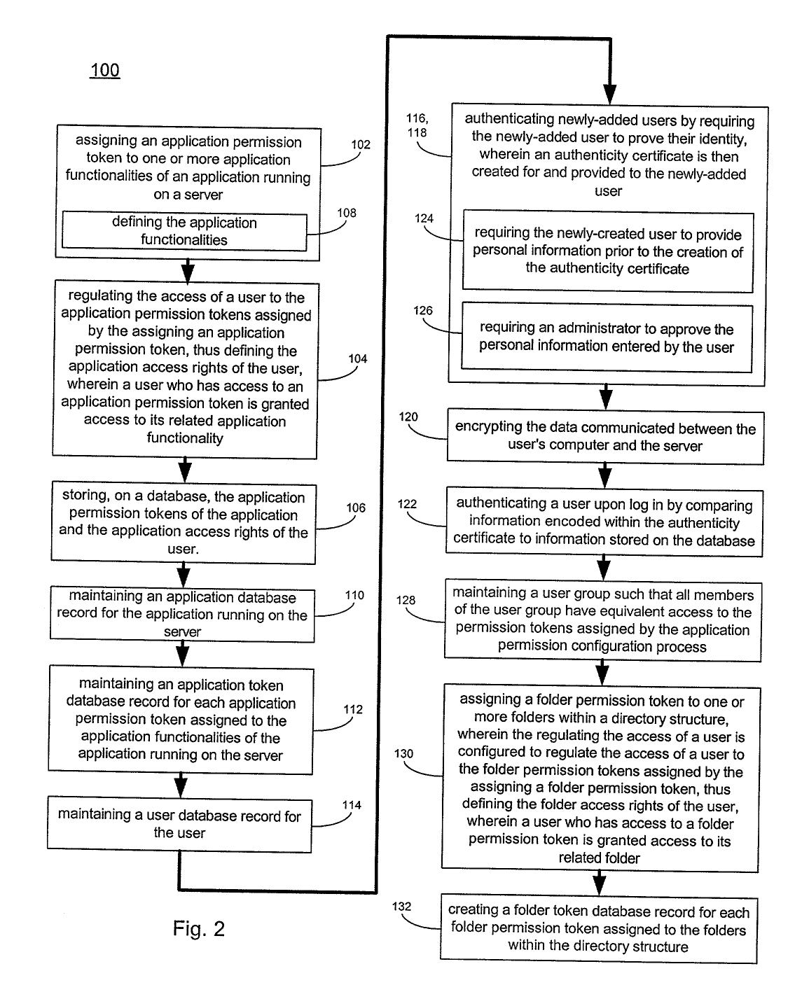

Referring to FIG. 2, a method 100 for regulating the application functionality and network access of a user is shown. An application permission token is assigned 102 to one or more application functionalities of an application running on a server. By regulating 104 the access the user has to these application permission tokens, the access rights of the user are defined in that a user who has access to an application permission token is granted access to its related application functionality.

These application permission tokens of the application and the application access rights of the user are stored 106 on a database. An administrator defines 108 the application functionalities of an application. An application database record is maintained 110 for each application running on the server. Further, an application database record is also maintained 112 for each application permission token assigned to the application functionalities of the application running on the server. Additionally, a user database record is maintained for each user who has access to the system.

Newly-added users are authenticated 116 by requiring the newly-added user to prove their identity. Once their identity is proven, an authenticity certificate is produced for and provided to 118 the newly-added user. This authenticity certificate identifies the newly-added user and includes a unique encryption key for encrypting 120 the data communicated between the user's computer and the server. A user is authenticated 122 upon log in by comparing the information encoded within the authenticity certificate to information stored on the database.

A newly-added user may be required 124 to provide personal information prior to the creation of the authenticity certificate. Additionally, the administrator may require 126 that the personal information entered by the user be approved prior to the creation of the authenticity certificate. A user group is maintained 128 such that all members of the user group have equivalent access to the permission tokens assigned by the administrator.

A folder permission token is assigned 130 to one or more folders within a directory structure. These folder permission tokens are then used to regulate the access of a user to the particular folders within the directory structure. This defines the folder access rights of the user, such that a user who has access to a folder permission token is granted access to its related folder. A folder token database record is produced 132 for each folder permission token assigned to the folders within the directory structure.

A number of embodiments of the invention have been described. Nevertheless, it will be understood that various modifications may be made without departing from the spirit and scope of the invention. Accordingly, other embodiments are within the scope of the following claims.

What is claimed is:

1. A process, residing on a server, for regulating application functionality and network access of a user, comprising:
an application permission configuration process for assigning an application permission token to one or more application functionalities of an application running on said server;
a user permission configuration process for regulating the access of a user to said application permission tokens assigned by said application permission configuration process to define application access rights of the user, wherein a user having access to an application permission token is granted access to its related application functionality; and
a database for storing said application permissions tokens of said application and said application access rights of said user.

2. The process of claim 1 wherein said application permission configuration process includes a functionality configuration process for defining said application functionalities.

3. The process of claim 2 wherein said application functionality is a web-based process.

4. The process of claim 2 wherein said application functionality is a uniform resource locator (URL).

5. The process of claim 1 further comprising an application record maintenance process for maintaining an application database record for said application running on said server.

6. The process of claim 5 further comprising an application token record maintenance process for maintaining an application token database record for each said application permission token assigned to said application functionalities of said application running on said server.

7. The process of claim 6 further comprising a user record maintenance process for maintaining a user database record for said user.

8. The process of claim 7 wherein said database includes a network domain database and a security framework database, and said application database records, said application token database records, and said user database records are stored on both said network domain database and said security framework database.

9. The process of claim 1 further comprising a user enrollment process that authenticates a newly-added user by requiring said newly-added user to prove their identity, wherein an authenticity certificate is then produced for and provided to said newly-added user.

10. The process of claim 9 wherein said authenticity certificate identifies said newly-added user and includes an encryption key for encrypting the data communicated between the user's computer and said server.

11. The process of claim 9 further comprising a network authentication process that authenticates a user upon log in by comparing information encoded within said authenticity certificate to information stored on said database.

12. The process of claim 9 wherein said user enrollment process further includes a user personal information input process that requires said newly-added user to provide personal information prior to the creation of said authenticity certificate.

13. The process of claim 1 further comprising a role maintenance process for maintaining a user group such that all members of said user group have equivalent access to said permission tokens assigned by said application permission configuration process.

14. The process of claim 1 further comprising a folder permission configuration process for assigning a folder permission token to one or more folders within a directory structure, wherein said user permission configuration process is configured to regulate the access of a user to said folder permission tokens assigned by said folder permission configuration process, thus defining the folder access rights of said user, wherein a user who has access to a folder permission token is granted access to its related folder.

15. A method for regulating the application functionality and network access of a user, comprising:
assigning an application permission token to one or more application functionalities of an application running on a server;
regulating the access of a user to the application permission tokens assigned by said assigning an application permission token, thus defining the application access rights of the user, wherein a user who has access to an application permission token is granted access to its related application functionality; and
storing, on a database, the application permission tokens of the application and the application access rights of the user.

16. The method of claim 15 wherein said assigning an application permission token includes defining the application functionalities.

17. The method of claim 15 further comprising maintaining an application database record for the application running on the server.

18. The method of claim 15 further comprising maintaining an application token database record for each application permission token assigned to the application functionalities of the application running on the server.

19. The method of claim 15 further comprising maintaining a user database record for the user.

20. The method of claim 15 further comprising authenticating newly-added users by requiring the newly-added user to prove their identity, wherein an authenticity certificate is then produced for and provided to the newly-added user.

21. The method of claim 20 wherein the authenticity certificate identifies the newly-added user and includes a unique encryption key for encrypting the data communicated between the user's computer and the server.

22. The method of claim 20 further comprising authenticating a user upon log in by comparing information encoded within the authenticity certificate to information stored on the database.

23. The method of claim 20 wherein said authenticating newly-added users further includes requiring the newly-added user to provide personal information prior to the creation of the authenticity certificate.

24. The method of claim 23 wherein said authenticating newly-added users further includes requiring an administrator to approve the personal information entered by the user.

25. The method of claim 15 further comprising maintaining a user group such that all members of the user group have equivalent access to the permission tokens assigned by said assigning an application permission token.

26. The method of claim 15 further comprising assigning a folder permission token to one or more folders within a directory structure, wherein said regulating the access of a user is configured to regulate the access of a user to the folder permission tokens assigned by said assigning a folder permission token, thus defining the folder access rights of the user, wherein a user who has access to a folder permission token is granted access to its related folder.

27. The method of claim 32 further comprising producing a folder token database record for each folder permission token assigned to the folders within the directory structure.

28. A computer program product residing on a computer readable medium having a plurality of instructions stored thereon that, when executed by the processor, cause the processor to:
assign an application permission token to one or more application functionalities of an application running on a server;
regulate the access of a user to the application permission tokens assigned by said assigning an application permission token, thus defining the application access rights of the user, wherein a user who has access to an application permission token is granted access to its related application functionality; and
store, on a database, the application permission tokens of the application and the application access rights of the user.

29. The computer program product of claim 28 wherein said plurality of instructions further cause the processor to define the application functionalities.

30. The computer program product of claim 28 wherein said plurality of instructions further cause the processor to maintain an application database record for the application running on the server.

31. The computer program product of claim 28 wherein said plurality of instructions further cause the processor to maintain an application token database record for each application permission token assigned to the application functionalities of the application running on the server.

32. The computer program product of claim 28 wherein said plurality of instructions further cause the processor to maintain a user database record for the user.

33. The computer program product of claim 28 wherein said plurality of instructions further cause the processor to authenticate newly-added users by requiring the newly-added user to prove their identity, wherein an authenticity certificate is then produced for and provided to the newly-added user.

34. The computer program product of claim 33 wherein said plurality of instructions further cause the processor to authenticate a user upon log in by comparing information encoded within the authenticity certificate to information stored on the database.

35. The computer program product of claim 33 wherein said plurality of instructions further cause the processor to require the newly-added user to provide personal information prior to the creation of the authenticity certificate.

36. The computer program product of claim 28 wherein said plurality of instructions further cause the processor to maintain a user group such that all members of the user group have equivalent access to the permission tokens.
